(19) United States
(12) Patent Application Publication
(10) Pub. No.: US 2013/0270354 A1
(43) Pub. Date: Oct. 17, 2013

(54) VEGETATION CONTROL SYSTEM FOR DISTRIBUTION OF CHEMICALLY-BASED TREATMENTS

(71) Applicants: Burnett Geer DuBose, JR., Monetta, SC (US); Joseph Roy Weakland, III, Moultrie, GA (US); William Reeves Roy, Moultrie, GA (US)

(72) Inventors: Burnett Geer DuBose, JR., Monetta, SC (US); Joseph Roy Weakland, III, Moultrie, GA (US); William Reeves Roy, Moultrie, GA (US)

(73) Assignee: Helena Holding Company, Wilmington, DE (US)

(21) Appl. No.: 13/860,665

(22) Filed: Apr. 11, 2013

Related U.S. Application Data
(60) Provisional application No. 61/622,746, filed on Apr. 11, 2012.

(51) Int. Cl. A01M 7/00

(52) U.S. Cl. CPC A01M 7/005
USPC 239/1; 239/722

(57) ABSTRACT

A vegetation control system for use with chemically-based treatments includes at least one distribution apparatus and at least one reservoir mounted onto a mobile unit. Routed within a passageway or passageways in the distribution apparatus are one or more conduits. These conduits are configured to route the chemically-based treatment from the reservoir through the passageway(s) to an end of the distribution apparatus, having one or more nozzles. The vegetation control system may be used by an operator to target specific branches and other specified areas of vegetation for treatment. The distribution apparatus is mounted onto the mobile unit for application of the treatment in various areas.

### CROSS-REFERENCE TO RELATED APPLICATION

This application claims priority to U.S. Application No. 61/622,746, filed Apr. 11, 2012. The entirety of this priority application is incorporated herein by reference.

### BACKGROUND OF THE INVENTION

1. Field

The present disclosure relates to vegetation control systems, and particularly vegetation control systems for distribution of chemically-based treatments.

2. Background

For several reasons, controlling and managing the growth of trees and other types of vegetation located near power transmission lines is very important. Dangers can result from uncontrolled and unmanaged growth. For example, just one fallen tree or large tree branch could prevent transmission of electricity to thousands of homes and businesses. Failure to provide electricity to homes and businesses can lead to various other problems, which ultimately stems from failure to control and manage vegetation.

Because of the large potential impact of failing to properly control and manage vegetation, federal and state standards mandate that utility companies maintain sufficient clearances between vegetation and power transmission lines. To meet and/or exceed these standards, many utility companies implement vegetation management plans. Some plans specify monitoring vegetation growth and periodic trimming of vegetation located along pathways, which can in some cases span and reach tens of thousands of miles.

To address the full span and reach of these pathways of vegetation, utility companies spend millions of dollars implementing vegetation management plans and using transitory vegetation control systems.

One negative aspect associated with the cost and implementation of these plans and systems results from systems using sharp-edged components. Whether manually or remotely used by an operator, sharp-edged components such as saw blades must be used by highly-skilled operators who can quickly and efficiently navigate around power lines. However, regardless of their level of skill, the use of sharp-edged components still results in unavoidable issues. For example, injury can result from fallen debris, power lines could be accidentally cut, etc.

Some vegetation control systems have proposed chemically-treating vegetation. A few known systems have even specified the use of chemical-treatments. However, these systems are known for liberal and uncontrolled distribution of vegetation control products such as herbicides. The use of these types of systems can therefore result in unwanted and inadvertent treatment over areas which are not considered problematic.

Despite these potential issues, many utility companies find using chemical-treatments very effective. Treatments can be tailored to affect specific types of vegetation, which can generally reduce re-sprouting by effective treatment of entire plant families. Application of treatments can also be phased in over time to coordinate with expected growth patterns. Moreover, using chemical-treatments alone can also avoid various issues and costs associated with using sharp-edge components.

For these reasons among others, there is a clear need for improved vegetation control systems designed for distribution of chemically-based treatments. The present invention fulfills this need and provides further related advantages, as described in the following summary.

### SUMMARY

The present invention is directed to vegetation control systems for use with chemically-based treatments. These systems include at least one distribution apparatus and at least one reservoir coupled to the distribution apparatus. Routed within one or more passageways in the distribution apparatus are one or more conduits. These conduits are configured to route the chemically-based treatment from the reservoir through the passageway(s) to a distribution end of the distribution apparatus. The conduits include one or more nozzles, which are used to apply the chemically-based treatment onto unwanted vegetation. The vegetation control system may be used by an operator to target specific branches and other specified areas of vegetation for treatment. The distribution apparatus is preferably mounted onto the mobile unit for application of the treatment in various areas.

A more complete understanding of the vegetation control systems disclosed herein will be afforded to those skilled in the art, as well as a realization of additional advantages and objects thereof, by consideration of the following detailed description. Reference will be made to the appended sheets which will first be described briefly.

### BRIEF DESCRIPTION OF THE DRAWINGS

The drawings described herein are for illustrative purposes only and are not intended to limit the scope of the present disclosure. In the drawings:

FIG. 1 shows a first configuration of a vegetation control system control system;

FIG. 2 shows one type of mobile unit for use with the vegetation control system shown in FIG. 1;

FIG. 3 shows a partial side view of the vegetation control system shown in FIG. 1;

FIG. 4 shows another partial side view of the vegetation control system shown in FIG. 1;

FIG. 5 shows a partial front view of the vegetation control system shown in FIG. 1, excluding a cab section of a mobile unit;

FIG. 6 is a side view of a second configuration of a vegetation control system;

FIG. 7 is a side view of the vegetation control system shown in FIG. 6, showing the span and reach of the boom sections.

FIG. 8 shows a partial view of a distribution end for use with the apparatuses shown in FIGS. 1 and 6;

FIG. 9A shows a partial view of an end upper section of a distribution apparatus, distributing a chemically-based treatment onto vegetation;

FIG. 9B shows another partial view of an upper end section of a distribution apparatus, distributing a chemically-based treatment onto vegetation;

FIG. 10 shows a set of controls for use with the vegetation control system; and

FIG. 11 shows one type of connection for routing a chemically-based treatment from a reservoir through the distribution apparatus.

### DETAILED DESCRIPTION

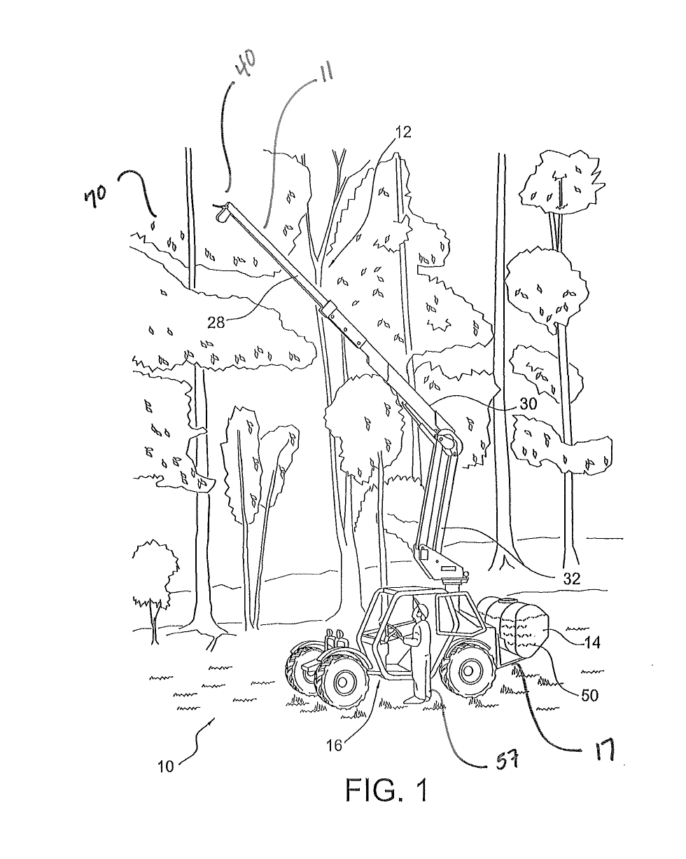

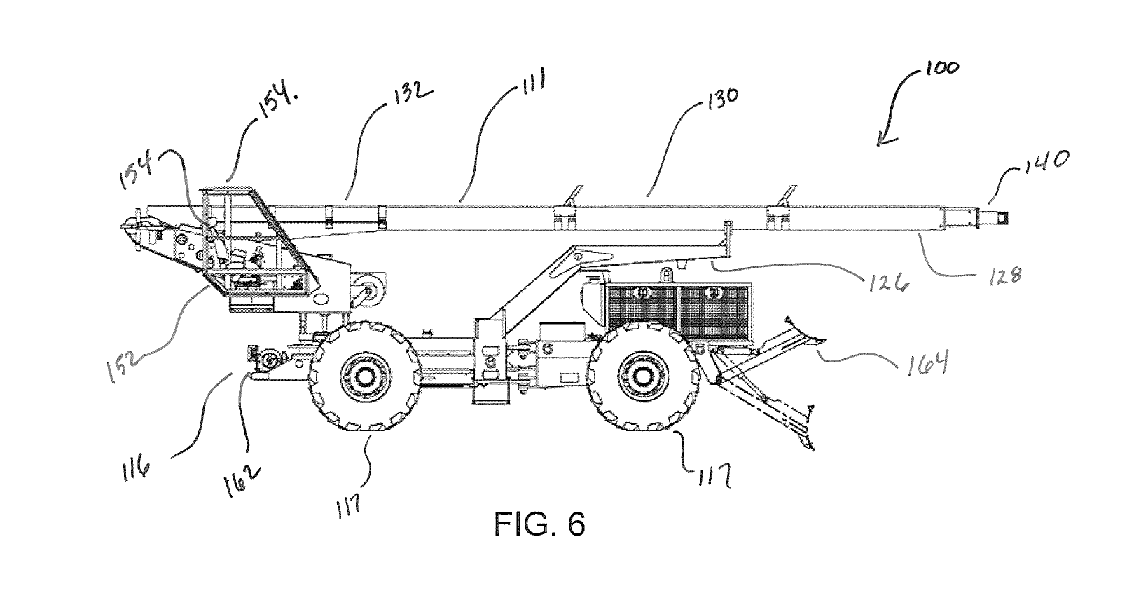

FIGS. 1 and 6 show configurations of vegetation control systems 10, 100 used for distribution of a chemically-based treatment 50 (FIG. 1). These vegetation control systems are used for control, management, and suppression of unwanted vegetation, particularly in areas which are elevated and difficult to reach. Such areas may be positioned near power transmission lines, lighting, and other types of equipment. In these areas, uncontrolled and unmanaged vegetation can easily cause interference with equipment operation. Other areas where the vegetation control system could be used include, but are not limited to, roadside areas such as those located in various municipalities and positioned near railroads, piping, fenced rows, wildlife openings, communication lines, waterways, canal ways, forestry roadsides and paths, fencelines, and pipelines.

Instead of using sharp-edge components, the systems 10, 100 are configured to distribute in a targeted manner a chemically-based treatment 50 (FIG. 1) for control, management, and suppression of unwanted vegetation. The type of treatment used, however, depends on many factors. Generally the treatment is specific to the type of vegetation to be controlled. Other factors that may be considered in determining the type of chemically-based treatment include: the environment in which distribution of the treatment occurs, (e.g. wetland aquatic areas and swamps), the growth pattern of the vegetation, the severity of vegetation encroachment, the potential for interference resulting from vegetation growth, and the type of plant species.

A chemically-based treatment may be a combination of herbicides, drift control agents, diluents, and additives. Preferably, a foliar prescription is used for enhanced leaf penetration and protection of grasses. One known herbicide suitable for use is sold by the DuPont Corporation under the brand name KRENITE®.

Application of the chemically-based treatment may be targeted to branches of vegetation, particularly during periods where foliage is limited. For example, during times when the climate is colder many deciduous trees are without foliage. During these times, a dormant prescription may be utilized, which provides for enhanced bark penetration. Generally, within one to two weeks after application of the chemically-based treatment, vegetation will gradually begin to wither.

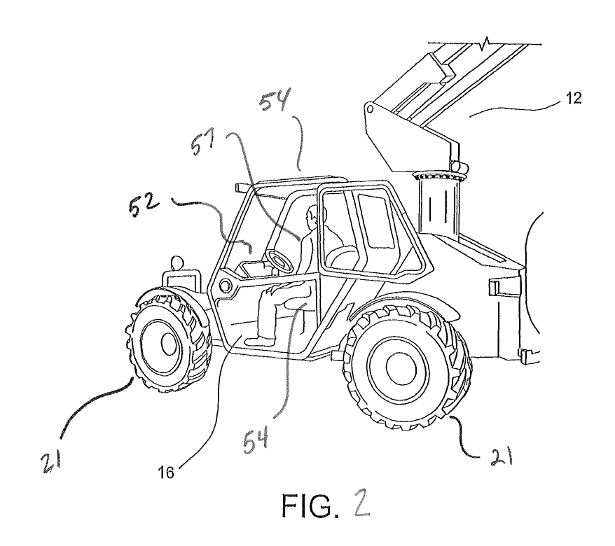

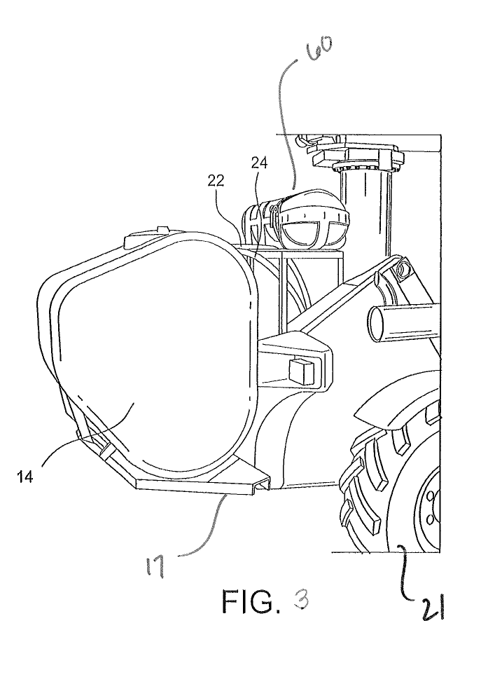

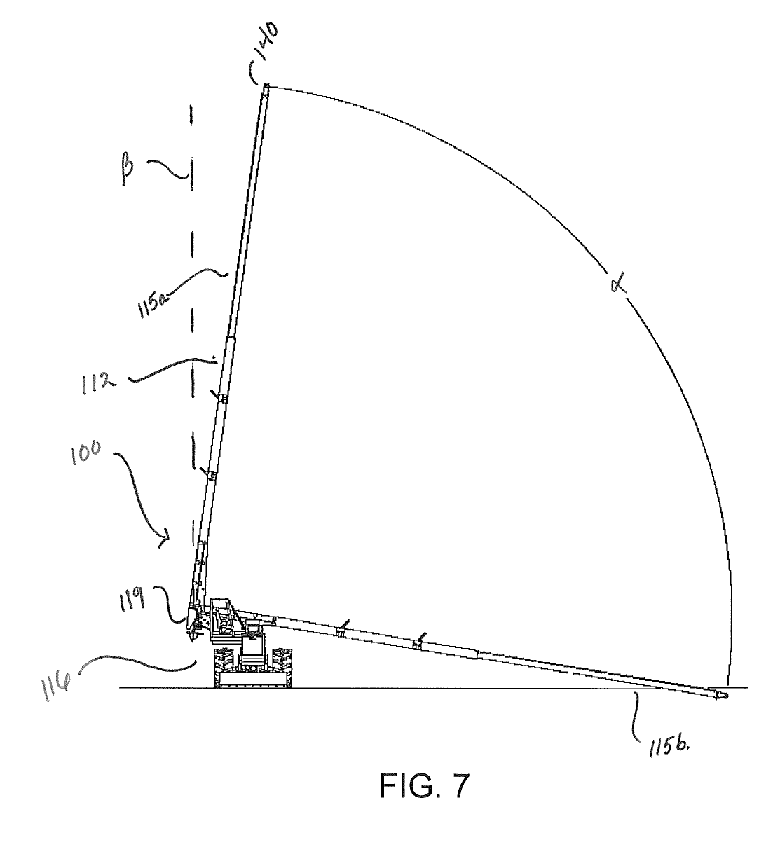

Referring to FIGS. 1-5, this configuration of the vegetation control system 10 includes at least one distribution apparatus 12 and at least one reservoir 14 coupled to the distribution apparatus. The distribution apparatus 12 is coupled to one or more reservoirs 14 containing chemically-based treatment(s) 50. FIGS. 6 and 7 show another configuration of a vegetation control system 100. This configuration also includes a distribution apparatus 112 and one or more reservoirs 114 (not shown) containing chemically-based treatment(s) 50.

Each configuration of the distribution apparatus 12, 112 includes an extendable device 11, 111 with a plurality of extension sections 28, 30, 128, 130, and a lower section 32, 132 that preferably mount to mobile units 16, 116. The second system configuration, however, optionally includes a secondary arm 1 for positioning of the extendable device 111. The distribution apparatuses 12, 113 basically include crane assemblies having a plurality of telescopic boom sections 15, 115. Suitable crane assemblies include hydraulic crane assemblies such as those manufactured by Altec. These types of crane assemblies generally have boom lengths ranging from about 50 feet to about 150 feet. Longer or shorter boom lengths may be specified, however, depending on the area(s) to be treated. Preferred boom configurations have a reach of at least about 75 feet from the ground.

The distribution assemblies 12, 112 may include a telescopic articulating aerial device such as those manufactured by Altec and sold as model number AT37-G. This type of device includes a hydraulically powered boom, having a lower boom section and an upper articulating arm. Boom articulation for the lower section ranges from about 25° to about 75°, while boom articulation for the articulation arm ranges from about 7° to about 90°. When the boom is in a stowed position suitable for travel, it has an overall height of approximately 10 feet. Other ranges of articulation may be suitable, depending on the chosen configuration of the distribution apparatus. Preferably, the boom is manufactured from one or more materials which provide sufficient chemical and weather resistant for frequent exposure to various weather conditions. For example, the boom may be manufactured from fiberglass composite materials that include electrical insulation. FIG. 7 shows one example of the angular span and reach of telescopic boom sections moving from a first position 115a to a second position 115b. The angular span a shown in FIG. 7, however, should not be construed as limiting. The angular span may have a reach spanning up to 180° with respect to a vertical axis β, having a vertex originating at a pivot area 119 of the lower boom section.

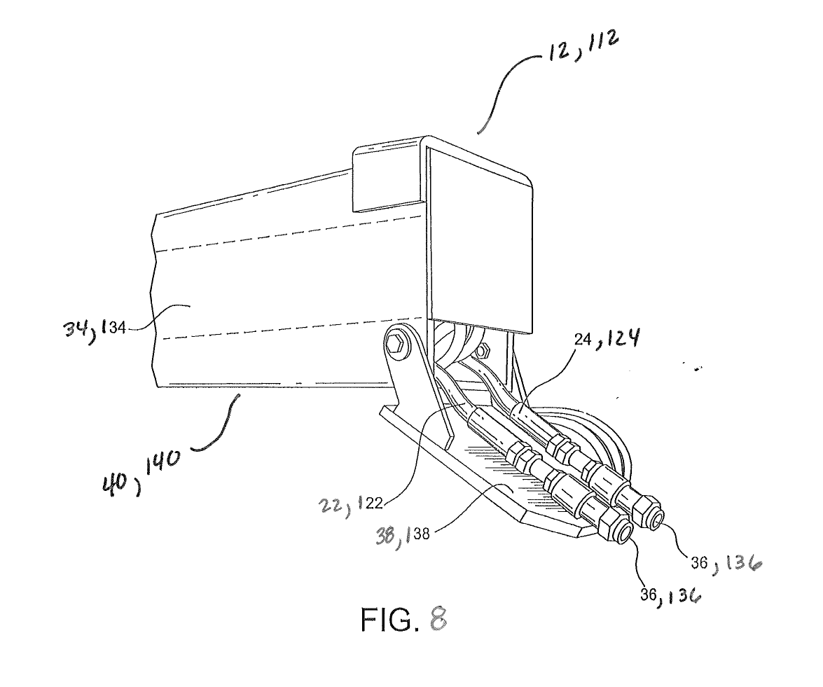

As shown particularly in FIG. 8, passageways 34, 134 are defined within each distribution end 40, 140 of the apparatuses for routing of conduits 22, 24, 122, 124 to nozzles 36, 136 which are coupled to the reservoir. A mounting unit 38, 138 is used to hold the nozzles in place at the distribution end 40, 140 of each apparatus 12, 112.

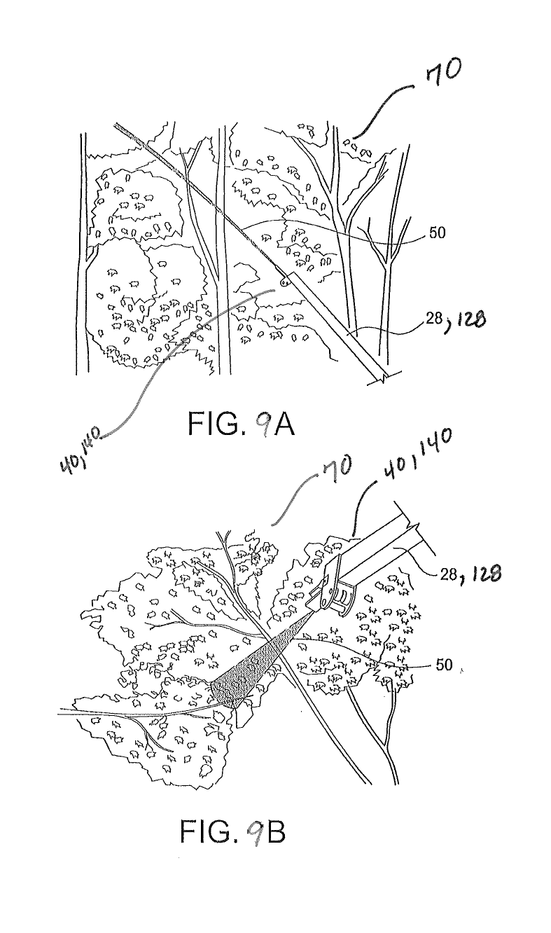

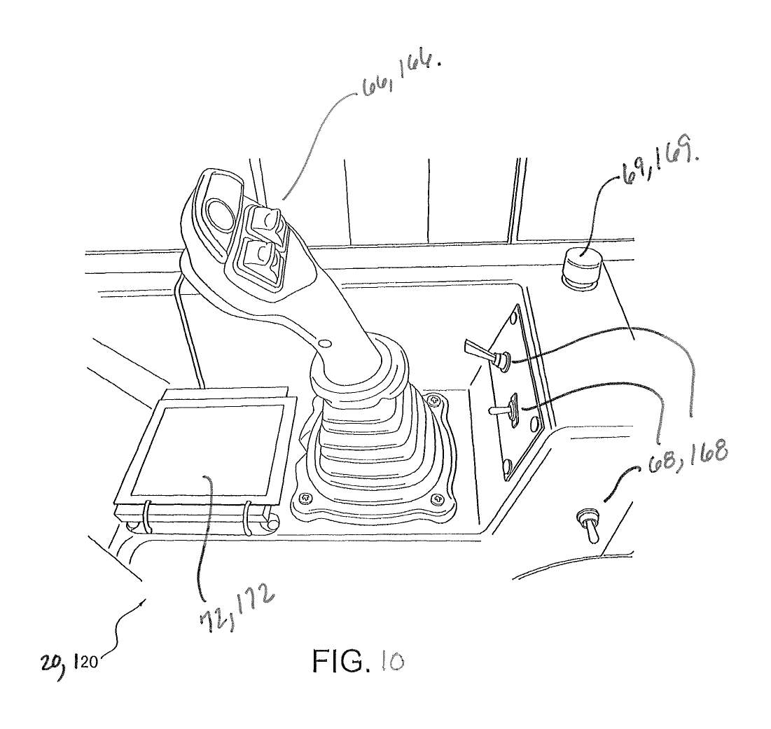

Defined within each distribution apparatus 12, 112 are passageways 34, 134 which may be used for routing conduits 22, 24, 122, 124 from the reservoir 14, 114 to the distribution end 40, 140. At this end of the apparatus, nozzles 36, 136 are used to distribute the chemically-based treatment onto vegetation, as shown particularly in FIGS. 9A and 9B.

Referring to FIGS. 8, 9A, and 9B, nozzles 36, 136 are used within each distribution apparatus 12, 112 to target specific branches and/or leaves of vegetation 70. Suitable nozzles include TEEJET® solid stream, spray, and fan type nozzles which can distribute chemically-based treatments at various distances and rates. Nozzle types suitable for use within the distribution assembly may include, but are not limited to ¼ inch STREAMJET® Solid Stream Nozzles, having a 0040 orifice size. These types of nozzles are rated for liquid pressures ranging from about 15 pounds per square inch (psi) to about 60 psi with a capacity per nozzle ranging from about 2.45 gallons per minute (gpm) to about 5.0 gallons gpm. Another type of nozzle suitable for use within the distribution assembly is the TEEJET® 1540 spray nozzle.

Coupled to each nozzle is a conduit 22, 24, 122, 124 which is used to route the chemically-based treatment from the reservoir 14, 114 to the distribution end 40, 140 of each apparatus 12, 112. These conduits are manufactured from one or more materials which are chemically compatible with the chemically-based treatment and suitable for a particular applications of chemical treatment(s).

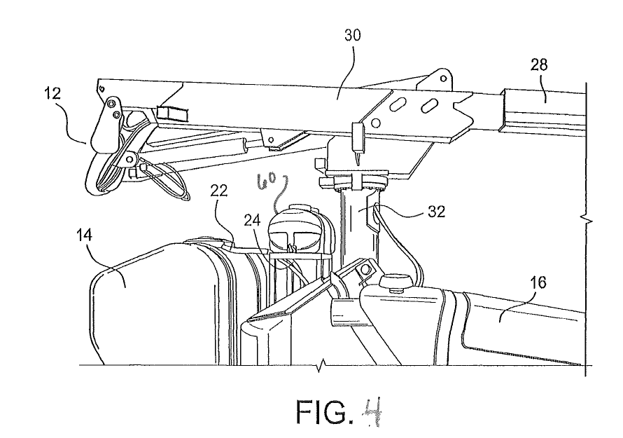

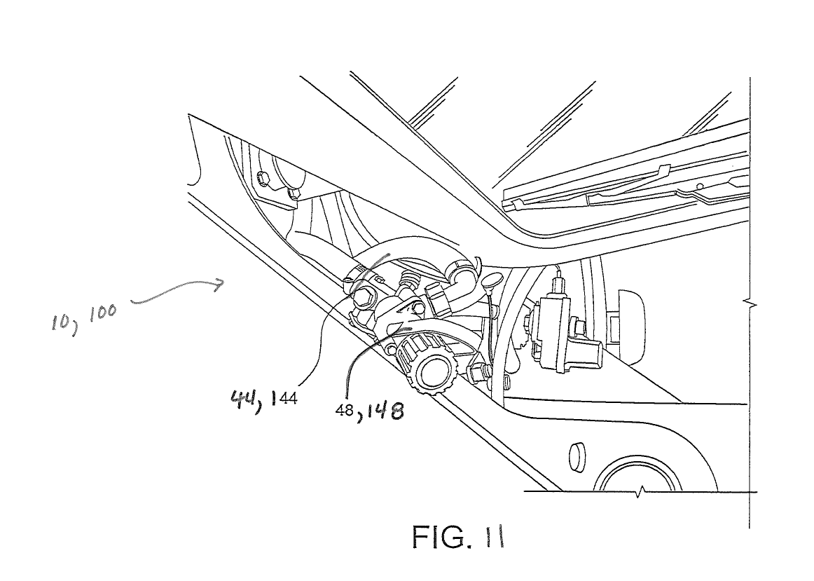

As shown in FIGS. 4 and 11, conduits 22, 24, 122, 124 are routed from a supply end 44, 144 of each distribution apparatus to its respective distribution end 40, 140 (FIG. 8). The conduits are coupled to at least one reservoir 14, 114 that houses the chemically-based treatment 50. The reservoir(s) is/are of sufficient size and shape for mounting onto a mobile unit 16, 116. Optionally, a mounting cradle 17, 117 may be used for mounting the reservoir(s) onto the mobile unit. The cradle may include flexible coupling devices, such as bands (not shown) having a width of about 2.5 inches and a length of about 74.5 inches. One or more weight bearing steps may also be coupled to the mounting cradle and/or the mobile unit. The step(s) facilitate(s) positioning, filling, and emptying of the reservoir(s) by an operator.

The reservoir(s) has/have sufficient capacity to distribute the chemically-based treatment onto vegetation over long periods. In one configuration of the system, a reservoir can have a capacity of about 250 gallons. The shape and sizes shown in the figures, however, are not to be construed as limiting. The reservoir may have any shape and size that is suitable for relatively stable mounting onto a mobile unit. The reservoir is manufactured from weather and chemically resistant materials such as polyethylene. Suitable reservoirs include those manufactured by Ace Roto-Mold, a division of Den Hartog Industries.

Preferably, disposed between the reservoir(s) and the conduits is a pumping system 42 142. The pumping system 42, 142 is used for positive displacement of the chemically-based treatment from the reservoir through the passageway in the distribution apparatus to the distribution end. Suitable pumping systems include those manufactured by UDOR or any other pump manufacturer. One pump type for use in the pumping system is the UDOR Kappa 40/VA Series Pump rated for 550 revolutions per minute, 580 pounds per square inch (psi), 9.4 gpm to 12.7 gpm, and 0.4 to 2.7 kilowatts (kW). Coupled to the pumping system may be one or more valve assemblies 48, shown in FIG. 6, which further facilitate routing of the chemically-based treatment from the reservoir and the pumping system to the distribution end of the distribution apparatus.

Distribution apparatuses 12, 112 may be mounted onto mobile units 16, 116 having wheels 21, 121 or tracks (not shown). The mobile units are of sufficient size to allow for mounting of the distribution apparatus and the reservoir. Preferably, a mobile unit is an all-terrain vehicle to allow for movement along pathways positioned near power lines. In many cases, the pathways are uneven and located in areas that are infrequently traveled. As such, the mobile unit is preferably provided with various modes of positioning and steering for maneuverability of the distribution apparatus.

Mobile units which are suitable for use with the vegetation control system include those manufactured by the Bobcat Company. FIGS. 1 and 7 show a VERSAHANDLER® Telescopic Tool Carrier, manufactured by the Bobcat Company. This type of mobile unit is suited for coupling to a distribution apparatus, having telescopic tools such as those included on a crane assembly. Other types of mobile units, however, may include trucks, railcars, track vehicles, etc. Where the mobile unit is a vehicle preferably the unit is equipped with a diesel engine rated for about 100 to about 150 horsepower (hp) @ 2200 revolutions per minute (rpm). The mobile unit also preferably includes a heavy-duty transmission.

Preferred types of mobile units include a cab section 52, 152. The outer portion of the cab section may be coated with one or more materials that provide weather, corrosion, and abrasion resistance. For example, components the cab section may be manufactured from laminated materials such as LEXGARD® laminated polycarbonates, which are known to have abrasion resistant surfaces.

Contained within the cab section 52, 152 may be seating 56, 156 for one or more operators 57. Each cab section 52, 152 includes an upper cover 54, 154 that prevents operators from contacting chemical treatment(s) after distribution. Where a cab section is included, a container 60, having a washing fluid (not shown) may be coupled to the mobile unit 12. The container may be further coupled to a triggering or pumping mechanism, which facilitates washing of a windshield or other window on the cab section 52.

The cab section 52, 152 may also be coupled to the chassis of the mobile unit 16 such that the cab section pivots or tilts from up to about 40° to about 60° with respect to a horizontal axis of the chassis. This type of coupling allows for optimal positioning of the boom and treatment of vegetation.

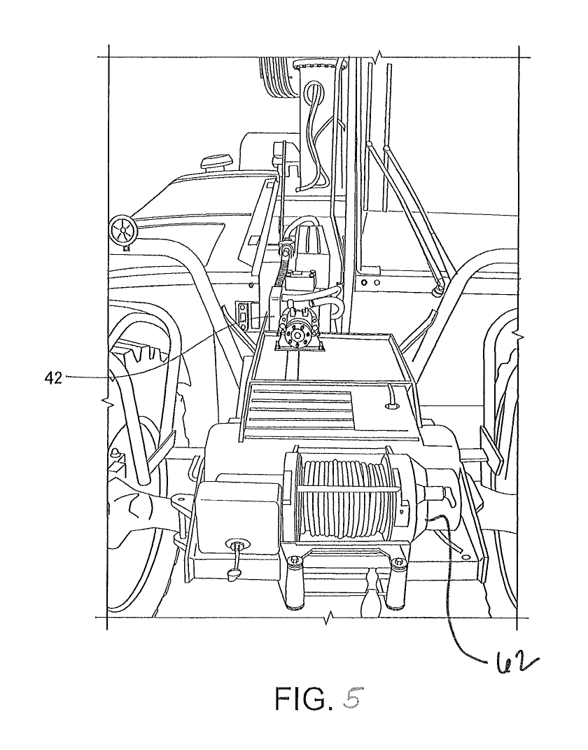

Controls 20 (FIG. 8) are also included in the system for targeted positioning of the distribution apparatus and the mobile unit. Optionally, the unit may be remotely manned, such that a cab section is optional. FIG. 5 shows a mobile unit 12, excluding the cab section 52. Other devices may be included, on the mobile unit, which facilitate use of the unit, especially in areas of rough terrain. For example, a winch 62, 162 may be coupled to the unit, which may be used by an operator to further position the unit when it is immovable. The winch may be mounted onto any appropriate section of the mobile unit. Preferably, the winch is rear-mounted and configured to haul up to about 20,000 pounds. One or more excavation component 164 may also be included on a mobile unit 116, as particularly shown in FIG. 6.

Also included within the cab section are controls 20, 120. FIG. 6 shows controls that include a joystick 66, 166. One or more joysticks or other types of controls may be used to position the distribution apparatus and thus allow for targeted distribution of the chemical treatment. Other types of controls include, but are not limited to levers 68, 168, buttons 69, 169 and pedals (not shown), configured for manual or remote use.

Preferably, the controls are hydraulically driven and ergonomically positioned within a cab section 52, 152 for operator use. Additional controls may, however, be provided for positioning and movement of the mobile unit and the pumping system. Such controls may even be remote. For example, depending on the condition of surrounding terrain, an operator may optionally position and move the vegetation control system, using remote controls.

Other modifications can be made to the mobile unit to improve the effectiveness of chemical treatment. For example, a Global Positioning System 72, 172 (GPS) may be integrated within the mobile unit such that a utility company can track implementation of its vegetation management plan.

While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A vegetation control system, comprising:
at least one distribution apparatus coupled to at least one reservoir containing a chemically-based treatment; and
at least one conduit routed through a passageway in the distribution apparatus to a distribution end for application of the chemically-based treatment onto vegetation.

2. The vegetation control system of claim 1, further comprising at least one nozzle coupled to the at least one conduit.

3. The vegetation control system of claim 1, wherein the distribution apparatus is a telescoping assembly.

4. The vegetation control system of claim 1, wherein the distribution apparatus is mounted to a vehicle.

5. The vegetation control system of claim 4, wherein the vehicle is configured for all-terrain travel.

6. The vegetation control system of claim 1, wherein the at least one conduit is coupled to a pump system.

7. The vegetation control system of claim 1, further comprising a mounting unit attached to an upper portion of the distribution apparatus.

8. The vegetation control system of claim 1, wherein the chemically-based treatment comprises a herbicide.

9. The vegetation control system of claim 2, wherein the at least one nozzle is a spray-type nozzle.

10. The vegetation control system of claim 2, wherein the at least one nozzle is a fan-type nozzle.

11. A vehicle for controlling vegetation, comprising:
a mobile unit; and
a vegetation control system, the system comprising:
at least one distribution apparatus coupled to a reservoir containing a chemically-based treatment; and
at least one conduit configured routed through a passageway in the distribution apparatus to a distribution end for application of the chemically-based treatment onto vegetation.

12. The vehicle of claim 11, wherein the mobile unit comprises a shielding unit disposed over an operator area.

13. The vehicle of claim 11, wherein the mobile unit is configured for all-terrain travel.

14. The vehicle of claim 11, further comprising a winch attached to the mobile unit.

15. A method of controlling vegetation, comprising:
distributing a chemically-based treatment from a vegetation control system, the system comprising:
at least one distribution apparatus coupled to a reservoir containing the chemically-based treatment; and
at least one conduit routed through a passageway in the distribution apparatus to a distribution end for application of the chemically-based treatment onto vegetation.
